(19) United States
(12) Patent Application Publication
(10) Pub. No.: US 2010/0329493 A1
(43) Pub. Date: Dec. 30, 2010

(54) HEARING APPARATUS AND METHOD FOR SUPPRESSING FEEDBACK IN A HEARING APPARATUS

(75) Inventors: Georg-Erwin Arndt, Obermichelbach (DE); Robert Bäuml, Eckental (DE); Andreas Tiefenau, Nurnberg (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/826,855

(22) Filed: Jun. 30, 2010

(30) Foreign Application Priority Data
Jun. 30, 2009 (DE) 10 2009 031 135.1

(51) Int. Cl. H04R 25/00

(52) U.S. Cl. 381/318

(57) ABSTRACT

A hearing apparatus and an associated method for suppressing feedback include a microphone emitting a microphone signal and a receiver picking up a receiver signal by subtracting a compensation signal from the microphone signal. The hearing apparatus includes a number of preset static first compensation filters for forming first compensation signals from the receiver signal and a first selection unit, which selects a first compensation signal in such a way that a feedback signal caused by the feedback is minimal in the receiver signal. An advantage thereof is that adaptation artifacts cannot occur.

### CROSS-REFERENCE TO RELATED APPLICATION

This application claims the priority, under 35 U.S.C. §119, of German Patent Application DE10 2009 031 135.1, filed Jun. 30, 2009; the prior application is herewith incorporated by reference in its entirety.

### BACKGROUND OF THE INVENTION

### Field of the Invention

The invention relates to a hearing apparatus for suppressing feedback having a microphone emitting a microphone signal and a receiver picking up a receiver signal by subtracting a compensation signal from the microphone signal. The invention also relates to a method for suppressing feedback in a hearing apparatus by subtracting a compensation signal from a microphone signal.

A frequent problem with hearing apparatuses is feedback between an output of the hearing apparatus and an input, in which such feedback is experienced as interference in the form of whistling. FIG. 1 illustrates the principle of acoustic feedback using the example of a hearing device or hearing aid 1. The hearing device 1 includes a microphone 2, which picks up an acoustic useful signal 10, converts it to an electrical microphone signal 11 and emits it to a signal processing unit 3. The microphone signal 11 is, for example, conditioned and amplified in the signal processing unit 3 and emitted to a receiver 4 as a receiver signal 12. In the receiver 4, the electrical receiver signal 12 is converted back into an acoustic output signal 13 and emitted to an eardrum 7 of a hearing device wearer.

The problem is that some of the acoustic output signal 13 reaches the input of the hearing device 1 by way of an acoustic feedback path 14, is overlaid there with the useful signal 10 and is picked up by the microphone 2 as a sum signal. Corresponding phasing and amplitude of the fed back output signal produce interference in the form of feedback whistle. Attenuation of acoustic feedback is low due to open hearing device coverage in particular, thereby exacerbating the problem.

Adaptive systems for feedback suppression have been available for some time in order to resolve the problem. With those systems, the acoustic feedback path 14 is simulated digitally. Simulation takes place, for example, through the use of an adaptive compensation filter 5, which is supplied, for example, by the signal 12 driving the receiver. After filtering in the compensation filter 5, a filtered compensation signal 15 is subtracted from the microphone signal 11. This ideally cancels the effect of the acoustic feedback path 14 and an input signal 16 of the signal processing unit 3 with feedback compensation results.

It is necessary to regulate or adjust the filter coefficients of the adaptive compensation filter 5 for effective feedback suppression. To that end, an analysis unit 6 is used to evaluate the input signal 16 of the signal processing unit 3 and check for possible feedback. The adjustment may cause artifacts to be produced, since additional signal components are generated if the compensation filters 5 are not optimally adaptive. Feedback whistle can also occur if a compensation filter 5 is not adapted optimally. European Patent EP 1 033 063 B1 discloses such a hearing device, with which two adaptive compensation filters operating in parallel are used to improve feedback suppression.

### SUMMARY OF THE INVENTION

It is accordingly an object of the invention to provide a hearing apparatus and a method for improved feedback suppression in a hearing apparatus, which overcome the hereinafore-mentioned disadvantages of the heretofore-known apparatuses and methods of this general type.

The concept of the invention is to select the compensation filter that is suitable for effective feedback suppression from a number of previously set static compensation filters.

With the foregoing and other objects in view there is provided, in accordance with the invention, a hearing apparatus for suppressing feedback. The hearing apparatus comprises a microphone emitting a microphone signal, a receiver picking up a receiver signal, a plurality of preset static first compensation filters for forming first compensation signals from the receiver signal, and a first selection unit selecting and subtracting a first compensation signal from the microphone signal in such a way that a feedback signal caused by the feedback is minimal in the receiver signal. This has the advantage that no adaptation artifacts can occur.

In accordance with another feature of the invention, the hearing apparatus can also include an adaptive first compensation filter for forming a further first compensation signal from the receivere signal. As a result, adaptation artifacts only occur if none of the static first compensation filters generates a better resulting signal than the adaptive first compensation filter.

In accordance with a further feature of the invention, the hearing apparatus can include a preset static second compensation filter for forming a second compensation signal from the receiver signal and a second selection unit connected between the microphone and the first selection unit. The second selection unit subtracts the second compensation signal from the microphone signal, if this allows a feedback signal caused by the feedback to be minimized in the receiver signal.

In accordance with an added feature of the invention, the second compensation filter can also model a mechanical feedback path within the hearing apparatus. This has the advantage that it is possible to compensate for feedback paths due to the mechanical structure of the hearing apparatus.

In accordance with an additional feature of the invention, the static first compensation filters can model different acoustic feedback paths. This allows “typical” feedback paths to be suppressed specifically.

In accordance with yet another feature of the invention, the filter coefficients of the static first compensation filters can be determined by feedback path measurements. This has the advantage that the filter coefficients can be adjusted individually to the use situation of the hearing apparatus.

In accordance with yet a further feature of the invention, the hearing apparatus can also be a hearing device or hearing aid.

With the objects of the invention in view, there is also provided a method for suppressing feedback in a hearing apparatus. The method comprises forming first compensation signals from a receiver signal using preset static first compensation filters, and selecting and subtracting one of the formed first compensation signals from a microphone signal in such a way that a feedback signal caused by the feedback is minimal in the receiver signal.

In accordance with another mode of the invention, the method includes forming a further first compensation signal from the receiver signal through the use of an adaptive first compensation filter.

In accordance with a further mode of the invention, the method includes forming a second compensation signal from the receiver signal through the use of a preset static second compensation filter and subtracting the second compensation signal from the microphone signal, if this allows a feedback signal caused by the feedback to be minimized in the input signal.

In accordance with an added mode of the invention, the second compensation filter can also model a mechanical feedback path within the hearing apparatus.

In accordance with an additional mode of the invention, the static first compensation filters can model different acoustic feedback paths.

In accordance with a concomitant mode of the invention, the filter coefficients of the static first compensation filters can also be determined by feedback path measurements.

Other features which are considered as characteristic for the invention are set forth in the appended claims.

Although the invention is illustrated and described herein as embodied in a hearing apparatus and a method for suppressing feedback in a hearing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic and block circuit diagram of a hearing device with feedback suppression according to the prior art;

FIG. 2 is a basic schematic and block circuit diagram of a hearing device having a number of static compensation filters;

FIG. 3 is a schematic and block circuit diagram of a further hearing device having a number of static compensation filters;

FIG. 4 is a basic schematic and block circuit diagram of a hearing device having a number of static compensation filters and an adaptive compensation filter;

FIG. 5 is a schematic and block circuit diagram of a further hearing device having a number of static compensation filters and an adaptive compensation filter;

FIG. 6 is a basic schematic and block circuit diagram of a hearing device having a number of static compensation filters, an adaptive compensation filter and an additional wideband static compensation filter; and

FIG. 7 is a schematic and block circuit diagram of a further hearing device having a number of static compensation filters, an adaptive compensation filter and an additional wideband static compensation filter.

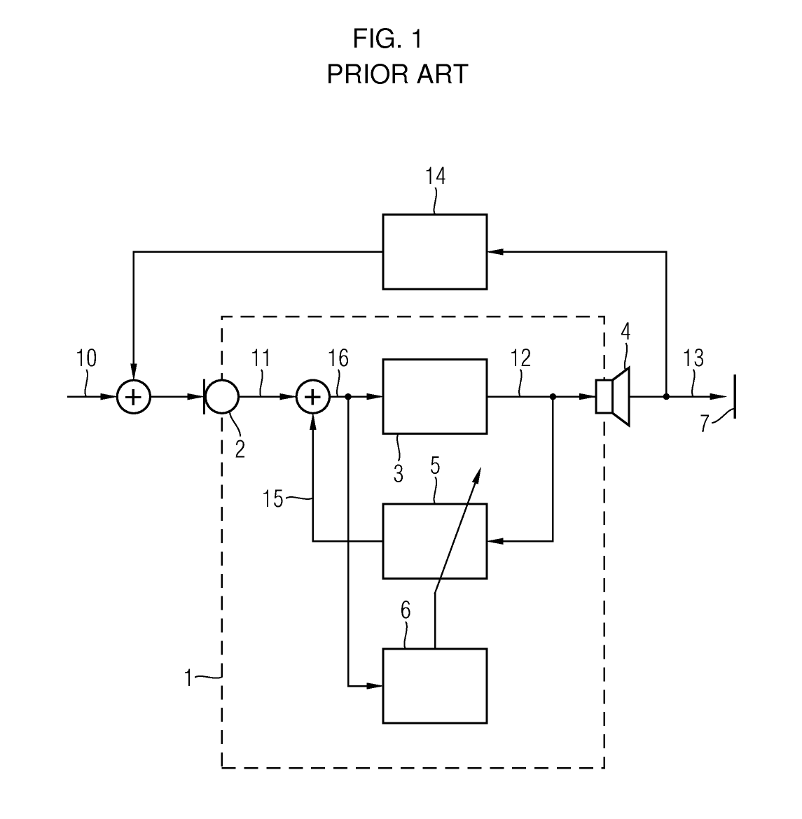

### DETAILED DESCRIPTION OF THE INVENTION

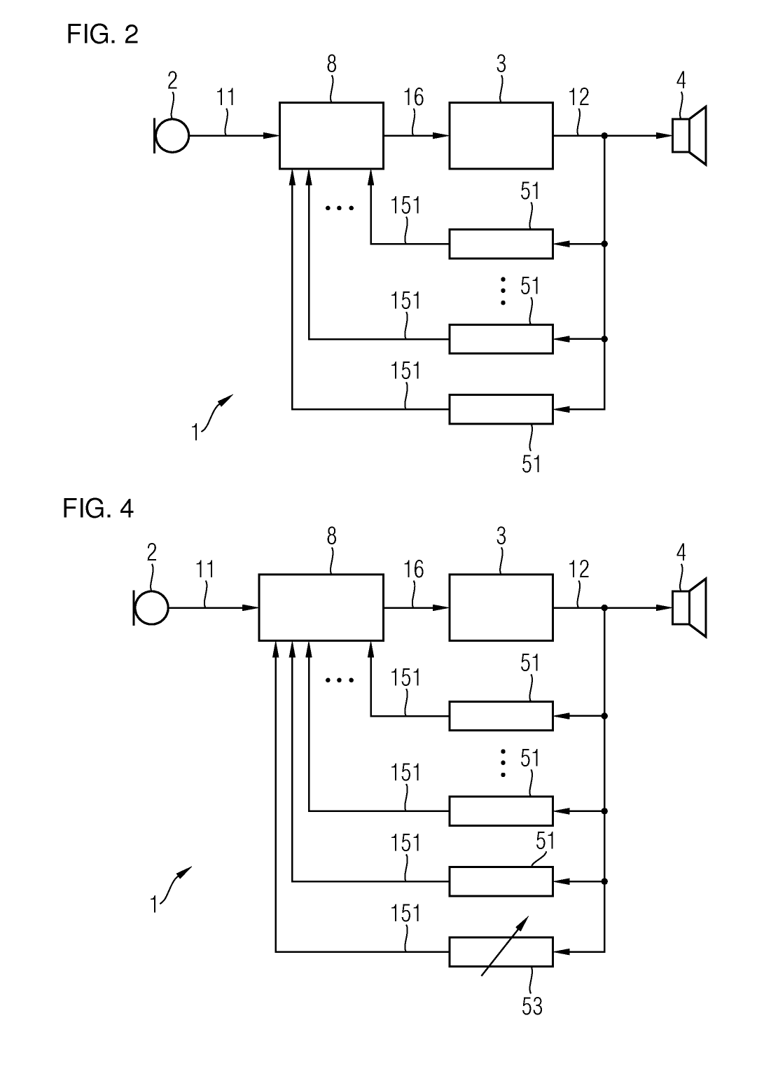

Referring now in detail to the figures of the drawings and first, particularly, to FIG. 2 thereof, in which the principle of the invention is illustrated with the aid of a circuit diagram, it is noted that in the exemplary embodiments which follow, the invention is described by using the example of a hearing device, although naturally the descriptions also apply to other hearing apparatuses. A microphone 2 of a hearing device 1 emits a microphone signal 11, which is picked up by a first selection unit 8. The microphone signal 11 is subject to a feedback signal, which is formed as a result of acoustic feedback between a receiver 4 of the hearing device 1 and the microphone 2. In order to suppress the feedback signal, a first compensation signal 151 is subtracted in the selection unit 8. Ideally, the first compensation signal 151 should compensate fully for the feedback signal.

Therefore, according to the invention, a number of first compensation signals 151 are generated from a receiver signal 12, which is present at the output of a signal processing unit 3 of the hearing device 1, with the aid of static first compensation filters 51. The receiver signal 12 is also the input signal of the receiver 4. The first selection unit 8 selects the most suitable compensation signal 151 from an analysis of the microphone signal 11 and the compensation signals 151 and emits the microphone signal, which thus has feedback compensation, as an input signal 16 to the signal processing unit 3.

The filter coefficients of the static first compensation filters 51 are set to “typical” feedback paths. The filter coefficients are determined by a hearing device acoustician using measuring techniques through the use of feedback path measurements, for example at the ear of a hearing device wearer. The use of static first compensation filters is possible, because in the everyday environment of a hearing device user there are a finite number of approximately identical wearing conditions and therefore feedback paths. A large proportion of feedback-critical situations can therefore be overcome.

The use of statically operating first compensation filters 51 means that adaptation artifacts do not occur. In order to avoid artifacts when switching between different first compensation signals 151, it is possible for a controlled cross-fading to take place between the compensation signals 151 rather than a “hard” switching.

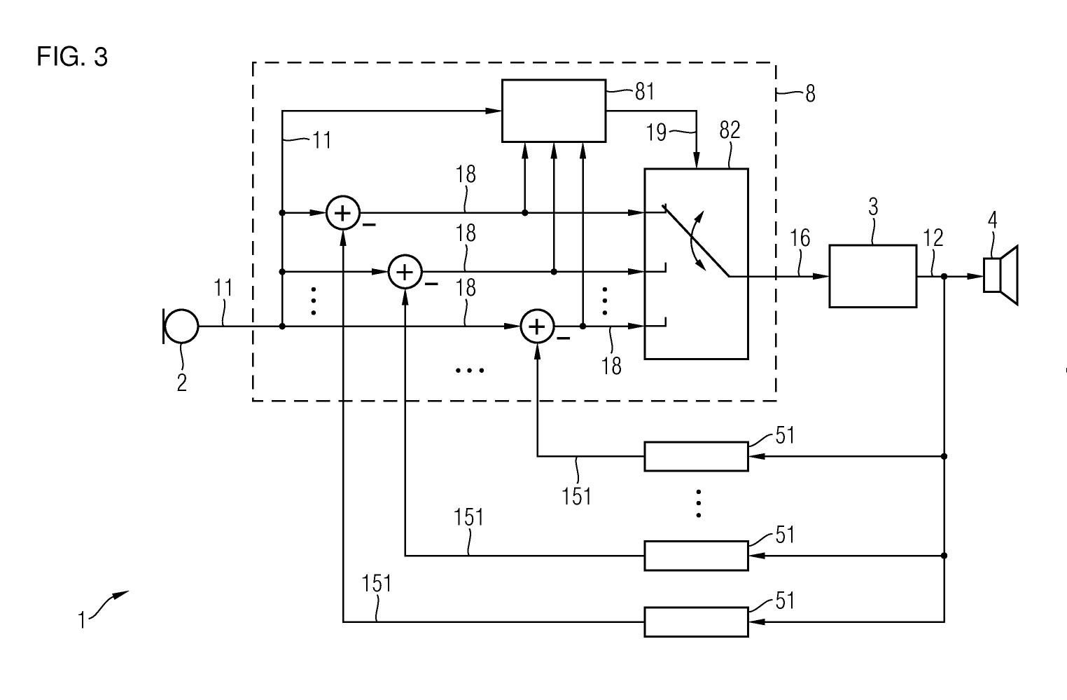

An application of the principle according to FIG. 2 is shown in FIG. 3. FIG. 3 shows a circuit diagram of a hearing device 1 having a microphone 2 to pick up sound and a receiver 4 to emit sound to the eardrum of a hearing device wearer. Feedback is eliminated from the microphone signal 11 emitted by the microphone 2 in a first selection unit 8 and the microphone signal 11 is then amplified, for example, in a signal processing unit and emitted as the receiver signal 12, between the microphone 2 and the receiver 4. A number of static first compensation filters 51 are used to obtain compensation signals 151 from the receiver signal 12. The compensation signals 151 are supplied to the first selection unit 8.

In the first selection unit 8, the compensation signals 151 are respectively subtracted from the microphone signal 11 and supplied as input signals 18 to a first switching unit 82. The first switching unit 82 switches one of the input signals 18 through and emits it as a further input signal 16 to the signal processing unit 3. The first switching unit 82 is controlled by a first analysis unit 81 with the aid of a first switching signal 19. To this end, the first analysis unit 81 analyzes the input signals 18 of the first switching unit 82 and the microphone signal 11. The input signal 18 having the most effective feedback suppression is selected on the basis of the analysis. The analysis unit 81 decides, for example, on the basis of a minimum energy of the input signal 18 or a minimization of a water mark in the input signal 18, which is impressed onto the receiver signal 12.

In order to also be able to counteract feedback paths, which cannot be stored statically in a hearing device, it is possible to combine the static first compensation filters 51 with an additional adaptive first compensation filter.

FIG. 4 shows the principle of combining static and adaptive compensation filters, by using a circuit diagram. A microphone 2 of a hearing device 1 emits a microphone signal 11, which is picked up by a first selection unit 8. The microphone signal 11 is subject to a feedback signal, which is formed as a result of acoustic feedback between a receiver 4 of the hearing device 1 and the microphone 2. In order to suppress this feedback signal, a first compensation signal 151 is subtracted in the first selection unit 8. The first compensation signal 151 should ideally be identical to the feedback signal.

Therefore, according to the invention, a number of first compensation signals 151 are generated from a receiver signal 12 with the aid of static first compensation filters 51. The receiver signal 12 is present at the output of a signal processing unit 3 of the hearing device 1. The receiver signal 12 is also the input signal of the receiver 4. An adaptive first compensation filter 53 also generates a further first compensation signal 151 from the receiver signal 12.

The first selection unit 8 selects the most suitable signal from an analysis of the microphone signal 11 and the compensation signals 151 and emits the microphone signal which thus has feedback compensation, as an input signal 16 to the signal processing unit 3.

Adaptation artifacts then only occur if none of the static first compensation filters 51 generates a better resulting input signal 18 than the adaptive first compensation filter 53. In the case of a better static first compensation filter 51, an adaptation control of the adaptive first compensation filter 53 can also adopt the former's filter coefficients as a start value for the adaptation.

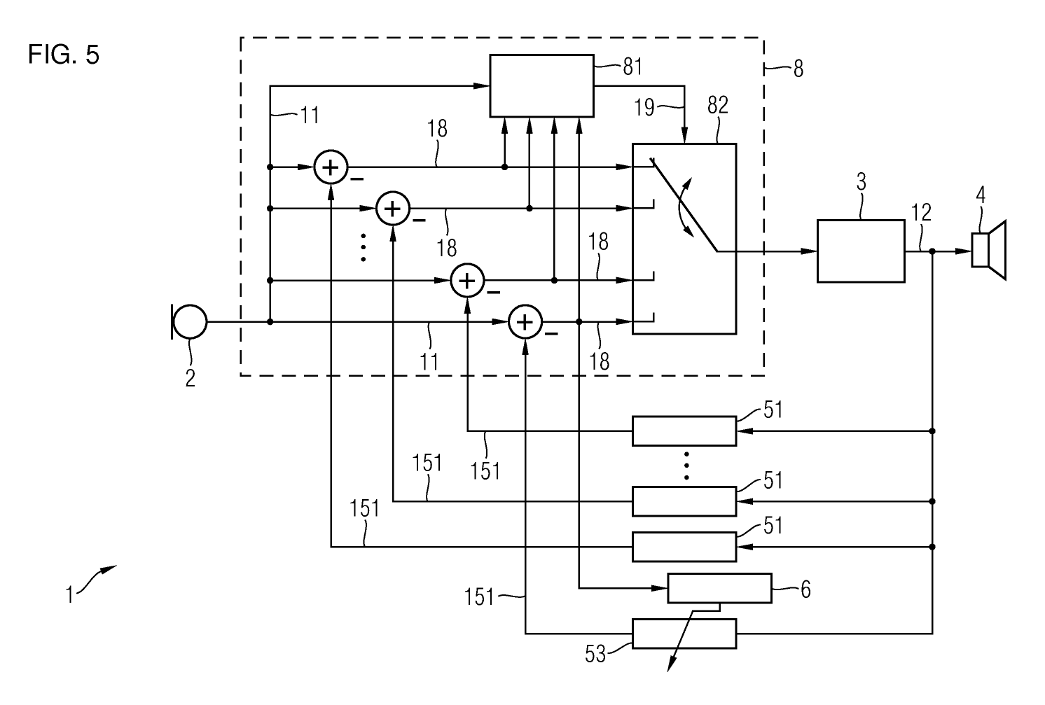

An application of the principle according to FIG. 4 is shown in FIG. 5. FIG. 5 shows a circuit diagram of a hearing device 1 having a microphone 2 to pick up sound and a receiver 4 to emit sound to the eardrum of a hearing device wearer. Feedback is eliminated from the microphone signal 11 emitted by the microphone 2 in a first selection unit 8 and the microphone signal 11 is then amplified, for example in a signal processing unit, and emitted as the receiver signal 12, between the microphone 2 and the receiver 4. A number of static first compensation filters 51 and an adaptive first compensation filter 53 are used to obtain compensation signals 151 from the receiver signal 12. The compensation signals 151 are supplied to the first selection unit 8.

In the first selection unit 8, the compensation signals 151 are respectively subtracted from the microphone signal 11 and supplied as the input signal 18 to a first switching unit 82. The first switching unit 82 switches one of the input signals 18 through and emits it as the input signal 16 to the signal processing unit 3. The first switching unit 82 is controlled by a first analysis unit 81 with the aid of a first switching signal 19. To this end, the first analysis unit 81 analyzes the input signals 18 of the first switching unit 82 and the microphone signal 11. The input signal 18 having the most effective feedback suppression is selected on the basis of the analysis. The analysis unit 81 decides, for example, on the basis of a minimum energy of the input signal 18 or a minimization of a water mark in the input signal 18, which is impressed onto the receiver signal 12.

The adaptive first compensation filter 53 is controlled with the aid of an analysis unit 6. The analysis unit 6 evaluates the first compensation signal 151 of the adaptive first compensation filter 53 subtracted from the microphone signal 11 and sets the filter coefficients of the adaptive first compensation filter 53 correspondingly.

There is also a further, mechanical, feedback path within the hearing device, as well as the changing external acoustic feedback path. This further path is generally only subject to minor fluctuations and is primarily a function of the structure of the hearing device. This mechanical feedback can be suppressed by a further static compensation filter separately from the first compensation filters. This has the advantage that, unlike an adaptive filter, such a filter can be used wideband since it does not produce any artifacts due to potential incorrect adaptation of the filter coefficients. It is therefore possible to achieve greater maximum amplification of the hearing device by obliterating the feedback element due to housing sound.

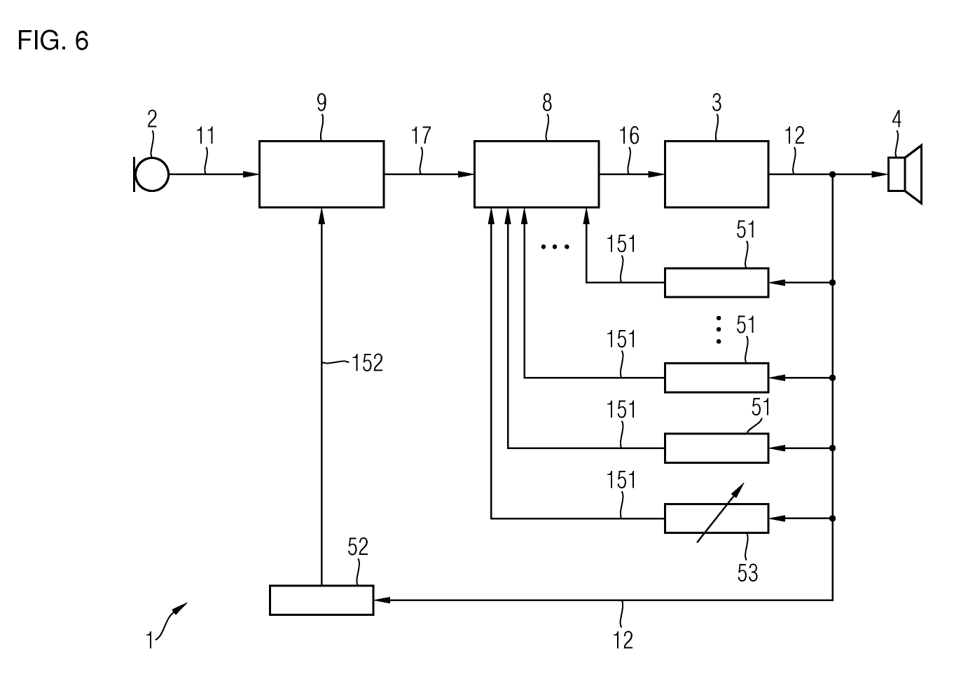

FIG. 6 shows the use of an additional static compensation filter, in principle. FIG. 6 uses a circuit diagram to show a second selection unit 9 in addition to the components described above in FIG. 4 between the microphone 2 and the first selection unit 8. A second compensation signal 152 is formed by a static second compensation filter 52 from the receiver signal 12. The filter coefficients of the second compensation filter are selected in such a way that mechanical feedback in the hearing device housing is suppressed. The selection unit 9 selects whether the microphone signal 11 or a differential signal between the microphone signal 11 and the second compensation signal 152 is present as an input signal 17 at the first selection unit 8.

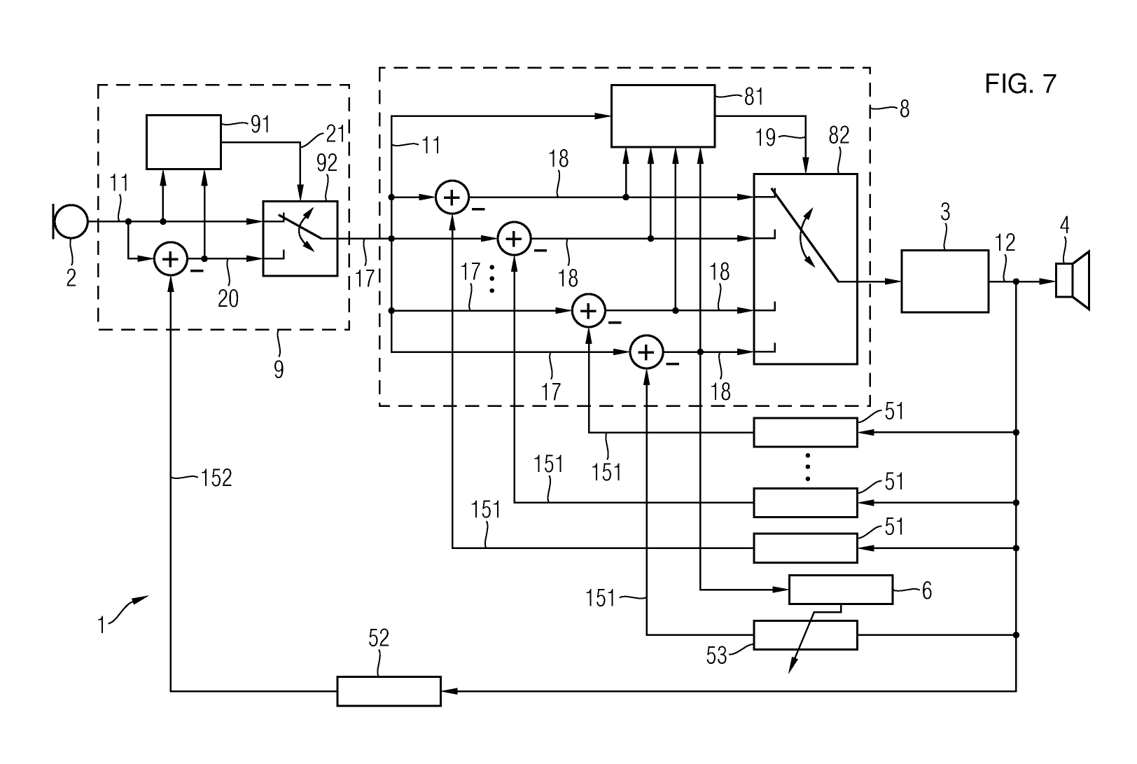

FIG. 7 shows the application of the principle according to FIG. 6 by way of example. FIG. 7 shows the circuit diagram of a hearing device 1 according to FIG. 5, extended to include a static second compensation filter 52 and a second selection unit 9. The selection unit 9 includes a second switching unit 92 and a second analysis unit 91. The compensation signal 152 of the second compensation filter 52 is subtracted from the microphone signal 11 and supplied to the second switching unit 92 as an input signal 20. The microphone signal 11 itself is present at a further input of the switching unit 92. The second switching signal 21 of the second analysis unit 92 controls the second switching unit 92. The second analysis unit 91 identifies whether or not mechanical feedback is present, from a comparison of the microphone signal 11 with the input signal 20, both of which are supplied to the second analysis unit 91. The switching through of the signal 20 with reduced feedback is initiated correspondingly and the second switching unit 92 emits an output signal 17 to the first selection unit 8.

1. A hearing apparatus for suppressing feedback, the hearing apparatus comprising:
a microphone emitting a microphone signal;
a receiver picking up a receiver signal;
a plurality of preset static first compensation filters for forming first compensation signals from the receiver signal; and
a first selection unit selecting and subtracting a first compensation signal from the microphone signal in such a way that a feedback signal caused by the feedback is minimal in the receiver signal.

2. The hearing apparatus according to claim 1, which further comprises an adaptive first compensation filter for forming a further first compensation signal from the receiver signal.

3. The hearing apparatus according to claim 1, which further comprises:
a preset static second compensation filter for forming a second compensation signal from the receiver signal; and
a second selection unit connected between said microphone and said first selection unit for subtracting the second compensation signal from the microphone signal if the subtraction of the second compensation signal would allow a feedback signal caused by the feedback to be minimized in the receiver signal.

4. The hearing apparatus according to claim 3, wherein said second compensation filter models a mechanical feedback path within the hearing apparatus.

5. The hearing apparatus according to claim 1, wherein said static first compensation filters model different acoustic feedback paths.

6. The hearing apparatus according to claim 5, wherein said static first compensation filters have filter coefficients to be determined by feedback path measurements.

7. The hearing apparatus according to claim 1, wherein the hearing apparatus is a hearing aid.

8. A method for suppressing feedback in a hearing apparatus, the method comprising the following steps:
forming first compensation signals from a receiver signal using preset static first compensation filters; and
selecting and subtracting one of the formed first compensation signals from a microphone signal in such a way that a feedback signal caused by the feedback is minimal in the receiver signal.

9. The method according to claim 8, which further comprises forming a further first compensation signal from the receiver signal using an adaptive first compensation filter.

10. The method according to claim 8, which further comprises:
forming a second compensation signal from the receiver signal using a preset static second compensation filter; and
subtracting the second compensation signal from the microphone signal if the subtraction of the second compensation signal would allow a feedback signal caused by the feedback to be minimized in the receiver signal.

11. The method according to claim 10, which further comprises modeling a mechanical feedback path within the hearing apparatus with the second compensation filter.

12. The method according to claim 8, which further comprises modeling different acoustic feedback paths with the static first compensation filters.

13. The method according to claim 12, which further comprises determining filter coefficients of the static first compensation filters using feedback path measurements.
